(19) United States
(12) Patent Application Publication
(10) Pub. No.: US 2008/0196079 A1
(43) Pub. Date: Aug. 14, 2008

(54) DATA-BROADCAST-RECEIVING APPARATUS AND DISPLAY APPARATUS

(75) Inventors: Ye-Youl Lee, Seoul (KR); Si-Cheol Kim, Seoul (KR); Yoo-Seung Hwang, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/854,747

(22) Filed: Sep. 13, 2007

(30) Foreign Application Priority Data
Feb. 9, 2007 (KR) 10-2007-0013967

(51) Int. Cl. H04N 7/16

(52) U.S. Cl. 725/139

(57) ABSTRACT

A data-broadcast-receiving apparatus and a display apparatus are disclosed. The data-broadcast-receiving apparatus includes an application-classifying module that classifies a predetermined broadcast-service application into an execution application and a presentation application, an application-executing module that executes the execution application, and a communication module that transmits the presentation module. The display apparatus includes an OpenCable Application Platform (OCAP) browser that browses a predetermined broadcasting service using OCAP-HTML, a communication module that receives a predetermined application corresponding to the browsing operation, and an application-presenting module that executes the received application.

### CROSS-REFERENCE TO RELATED APPLICATION

This application claims priority from Korean Patent Application No. 10-2007-0013967 filed on Feb. 9, 2007, in the Korean Intellectual Property Office, the disclosure of which is incorporated herein in its entirety by reference.

### BACKGROUND OF THE INVENTION

1. Field of the Invention

Apparatuses consistent with the present invention relate to receiving and displaying data-broadcast, and more particularly, to an extension of OpenCable Application Platform (OCAP) middleware in order to provide a two-way service between a data-broadcast-receiving apparatus, that receives a predetermined application, and a display apparatus connected thereto by Institute of Electrical and Electronics Engineers (IEEE) 1394 for receiving and displaying data broadcast.

2. Description of the Related Art

The cable broadcast has advantages over other broadcasting mediums in two-way, high-speed, and high-capacity transmissions, which are most suitable for the next generation broadcasting integration service. A cable set-top box (STB) is required for two-way digital cable broadcasting.

Accordingly, a digital STB is necessary to embody the two-way service and to receive high-definition and high-sound quality transmissions.

The STB refers to a control box that can receive a broadcast and perform various additional functions. The main function of the STB is to receive broadcast data from a specific broadcast provider. However, the STB was developed to perform various additional functions such as a communication function, a personal video recorder function, (PVR), and an electronic program guide (EPG) function.

OpenCable, used as a digital cable broadcast standard, is divided into hardware and software. The hardware includes a STB and a point of deployment (POD) device that has a secure function and a reception-limited function separated from the STB. The STB and the POD device are separated for producing and providing a STB not subordinated to the solution of a specific provider in order to induce a consumer's purchase and reduce price.

The core of the software is the OpenCable Application Platform (OCAP) standard, which is middleware that is the foundation of applications for two-way service in cable broadcasting. OCAP can provide a web-based service to cable broadcasting, thereby providing an advanced two-way service to viewers.

OpenCable enables sharing of application software and a content using a common middleware platform, i.e., OCAP.

The high definition audio/video network alliance (hereinafter, referred to as HANA) solution for a device integration control and high definition (HD) content sharing by connecting a built-in digital television (DTV) and peripherals using IEEE 1394 has a decoder and a web browser within the DTV, and has a web-server and a control page within the peripherals.

The HANA-based solution can decode a digital broadcasting signal and an HD content stored in the peripheral in the DTV, and integrally control peripherals via a graphic user interface (GUI) by using a web-browser of the DTV. HANA can control all devices connected via IEEE 1394 using a single integrated remote controller.

The HANA provides a HANA device such as a HANA DTV, TV nodes, an audio/video hard disk drive (A/V HDD), and a HANA expandable Home Theater (XHT) STB (cable network interface unit (NIU)). The XHT STB provides an electronic program guide (EPG) in response to a user's request, transmission and reception of pay per view (PPV), video on demand (VOD), and shopping programs between devices, and user interface (UI) display using the Hypertext Markup Language (HTML) format.

If OCAP middleware is loaded on an OpenCable STB connected to a HANA device through IEEE 1394, a predetermined application operated on the Multimedia Home Platform (MHP) or OCAP middleware is not provided in the HTML format. Therefore, the predetermined application cannot be directly applied to the HANA device connected by IEEE 1394. Accordingly, the extension of OCAP loaded on the corresponding device is required in order to use an OCAP-based two-way service in the HANA device based on IEEE 1394.

A HANA UI, applications for a UI, and various HANA applications are operated based on a web-browser loaded on an HTML-based HANA DTV. However, OCAP 1.0 provides a Java-centered application called “OCAP-Java application” and a UI. Accordingly, Java applications of OCAP 1.0 cannot be operated in the HANA DTV based on the web-browser.

### SUMMARY OF THE INVENTION

The present invention provides dividing a predetermined broadcasting service application into an execution application and a presentation application in order to execute the execution application and to transmit the presentation application.

The present invention also provides receiving a predetermined application corresponding to browsing a predetermined broadcasting service in order to present the corresponding application, and to expand OCAP middleware.

The aspects of the present invention will become clear to those skilled in the art upon review of the following description, attached drawings and appended claims.

According to an aspect of the present invention, there is provided a data-broadcast-receiving apparatus including an application classifying module that classifies a predetermined broadcast-service application into an execution application and a presentation application, an application-executing module that executes the execution application, and a communication module that transmits the presentation module.

According to another aspect of the present invention, there is provided a display apparatus including an OCAP browser that browses a predetermined broadcasting service using OCAP-HTML, a communication module that receives a predetermined application corresponding to the browsing operation, and an application-presenting module that executes the received application.

According to still another aspect of the present invention, there is provided a data-broadcast-receiving method including classifying a predetermined broadcast-service application into an execution application and a presentation application, executing the execution application, and transmitting the presentation module.

According to another aspect of the present invention, there is provided a display method including browsing a predetermined broadcasting service using OCAP-HTML, receiving a predetermined application corresponding to the browsing operation, and executing the received application.

### BRIEF DESCRIPTION OF THE DRAWINGS

The above and other aspects of the present invention will become apparent by describing in detail preferred embodiments thereof with reference to the attached drawings, in which:

FIG. 1 depicts a two-way service-providing system according to an exemplary embodiment of the present invention;

FIG. 2 depicts a data-broadcast-receiving apparatus according to an exemplary embodiment of the present invention;

FIG. 3 depicts a display apparatus according to an exemplary embodiment of the present invention;

FIG. 4 is a flowchart of a data broadcast transmission according to an exemplary embodiment of the present invention;

FIG. 5 is a flowchart of a data-broadcast reception according to an exemplary embodiment of the present invention.

### DETAILED DESCRIPTION OF EXEMPLARY EMBODIMENTS

Exemplary embodiments of the present invention will be described in detail with reference to the accompanying drawings.

Aspects of the present invention may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

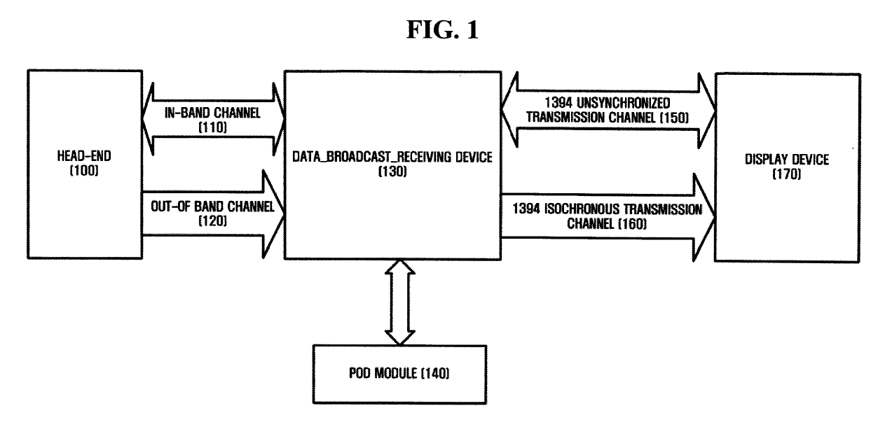

FIG. 1 depicts a two-way service-providing system according to an exemplary embodiment of the present invention.

A two-way service-providing system may include a head-end 100 that provides a predetermined broadcasting service based on Java and HTML, a data-broadcast-receiving device 130, a POD module 140, and a display device 170.

The head-end 100 includes an application server, that provides audio, video, a data-encoder system, a member-management system, a limited receiving system and a two-way service, and a system that configures the information as broadcast signals.

The data-broadcast-receiving device 130 classifies an application of a broadcasting service received from the head-end 100 into an execution application and a presentation application in order to execute the execution application.

The data-broadcast-receiving device 130 is provided with extended OCAP 2.0 middleware and complies with Consumer Electronics Association (CEA)-2027A and CEA 931B (CEA standards), and executes only the execution application among the broadcasting service provided by the head-end 100.

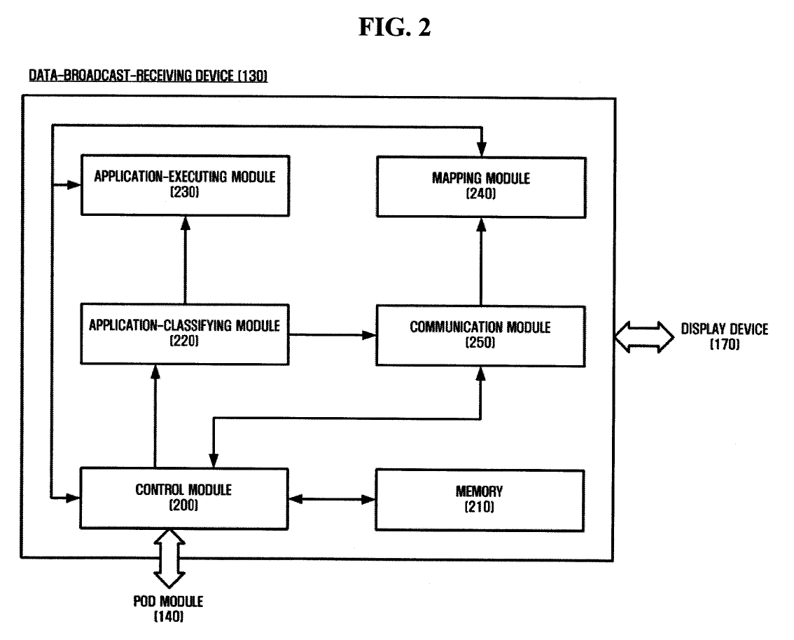

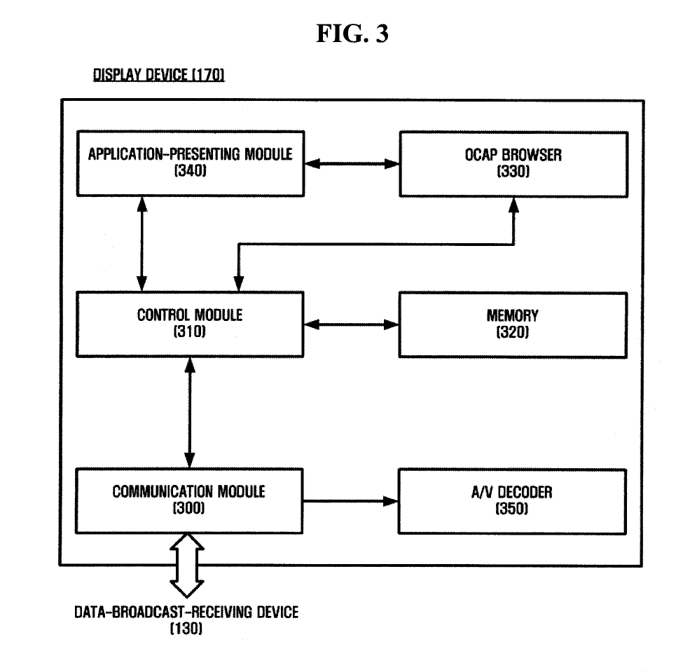

The data-broadcast-receiving device 130 executes only the execution application by classifying a received broadcasting service into an execution application that executes a cable card, a Data Over Cable Service Interface Specifications (DOCSIS) set-top gateway (DSG) and a tuner, and a presentation application that includes at least one of EPG, PPV, and VOD. This presentation application is provided to the display device 170 through the communication module 250, which will be described in detail with reference to FIGS. 2 and 3.

The CEA-2027A of the data-broadcast-receiving device 130 is an instruction-control-transmission standard based on a web browser, and CEA-931B is a remote controller-signal-transmission standard using a network.

Predetermined information is transmitted and received between the head-end 100 and the data-broadcast-receiving device 130 via an in-band channel 110 for transmitting a broadcast signal and an out-of band (OOB) channel 120 for providing additional information and two-way service information.

The data-broadcast-receiving device 130, which transmits and receives a predetermined broadcasting service received from the head-end 100, is connected to the display device 170 via an IEEE 1394 network.

Separated from the POD module 140 including a conditional access (CA) system, the data-broadcast-receiving device 130 tunes and demodulates a predetermined broadcast signal transmitted from the head-end 100 via the in-band channel 110 through a tuner (not shown) and a quadrate amplitude modulation (QAM) demodulator (not shown), and then sends the demodulated broadcast to the POD module 140.

An OOB receiver (not shown) included in the data-broadcast-receiving device 130 transmits data information such as channel tuning and a program guide provided from the head-end 100 to the POD module 140.

The data-broadcast-receiving device 130 and the POD module 140 are connected via a Personal Computer Memory Card International Association (PCMCIA) card interface.

The POD module 140 descrambles the cable program received via the in-band channel 110, and outputs the descrambled cable program to the data-broadcast-receiving device 130. After interpreting an instruction received from the head-end 100 by communicating with the head-end 100 using the OOB transceiver (not shown) provided by the data-broadcast-receiving device 130, the POD module 140 performs the instruction of the head-end 100 or transmits a user's input to the head-end 100 by communicating with a control module 200 of the data-broadcast-receiving device 130.

When predetermined information is sent to the POD module 140 by the tuner, the QAM demodulator and the OOB receiver, if the QAM demodulated signal is scrambled, the POD module 140 descrambles and sends multiplexed video and audio to a transport (TP) demultiplexer (now shown). The TP demultiplexer separates the multiplexed video and audio packet, and then sends the separated packets to a video decoder (not shown) and an audio decoder (now shown). The video decoder removes overhead (header information, start code, etc.) from the video packet, performs variable length decoding (VLD), restores the data to pixel values of the original screen through an inverse quantization, inverse discrete cosine transform (IDCT), and motion compensation, and then displays it on a monitor. The audio decoder decodes an audio packet using the Arc Consistency (AC)-3 algorithm, and then outputs it to a speaker.

In the data-broadcast-receiving device 130, the extended OCAP 2.0 middleware is loaded in order to transmit and receive a two-way service with a display device 170 connected based on IEEE 1394. The extended OCAP 2.0 middleware will be described in detail with reference to FIG. 2.

The display device 170 refers to a general HANA device. The display device 170, which is connected to the data-broadcast-receiving device 130 based on IEEE 1394, executes a predetermined application corresponding to a browsing operation of a user.

The display device 170 can be easily connected to a built-in XHT TV and a predetermined peripheral using a single line, control all peripherals using a remote controller of the built-in XHT TV, and receive a predetermined additional service based on a web browser.

Accordingly, the display device 170 also complies with CEA-2027A and CEA 931B (CEA standards).

The display device 170 may include an OCAP browser 330 that browses a predetermined broadcasting service by using OCAP-HTML, which will be described in detail with reference to FIG. 3.

A predetermined application corresponding to a browsing operation of an OCAP browser 330 (to be described with reference to FIG. 3) refers to the presentation application classified by the data-broadcast-receiving device 130. The predetermined application may include at least one of EPG, PPV and VOD operated on the OCAP middleware or MHP.

Because the predetermined application is not provided as in the HTML format when it is built on the OCAP middleware, the application cannot be directly applied in the related art.

FIG. 2 depicts a data-broadcast-receiving apparatus according to an exemplary embodiment of the present invention.

The data-broadcast-receiving device 130 classifies an execution application and a presentation application among broadcasting services which are based on Java and HTML provided by the head-end 100, and executes only the execution application and transmits the presentation application to the display device 170.

The data-broadcast-receiving device 130 may include an STB or an NIU which uses OCAP 2.0. In addition to general modules of the STB, the data-broadcast-receiving device 130 may include a control module 200, a memory 210, an application-classifying module 220, an application-executing module 230, a mapping module 240, and a communication module 250 as shown in FIG. 2.

That is, the data-broadcast-receiving device 130 is described based on the extended OCAP 2.0 standard.

A related art OCAP 2.0 architecture can be largely divided into an execution engine and a presentation engine, and is embodied through a Java application programming interface (API).

The execution engine performs an application in a related art OpenCable STB and a related art digital TV (DTV) integrated with the STB, and transmits components of OCAP 2.0. The execution engine also supports an independent interface in a platform in order to embody various hardware and software based on Java, and is configured with a Java virtual machine (JVM) and various APIs. Applications are compiled into Java byte code format, and are executed in the JVM.

The execution engine complies with digital video broadcasting (DVB) 1.. 1 about 90%, and provides a related art application programming environment including the JVM, networking, file input/output (I/O), and graphics.

Also, the execution engine provides a security design and a full HD TV application environment.

The execution application executed in the execution engine may include an application executing a cable card, DSG or a tuner, and are executed via the application execution module 230.

When a user requests execution of an application, the data-broadcast-receiving device 130 classifies an application corresponding to the user's request.

The classification of an application means that applications are classified into an application to be executed in an application-executing module 230 and a presentation application to be executed in a display device 170, and this classification is performed via the application-classifying module 220.

An application to be executed in the application-executing module 230 among applications classified by the application-classifying module 220 is processed in the data-broadcast-receiving device 130. An application to be executed in an application-presenting module 340 (as shown in FIG. 3) is transmitted to the display device 170 via an IEEE 1394 unsynchronized transmission channel 150 (as shown in FIG. 1) of the communication module 250.

The application-presenting module 340 will be described in detail with reference to FIG. 3.

The application-classifying module 220 is performed according to the extended OCAP 2.0 standard.

Table 1 shows the extended OCAP 2.0 standard of the data-broadcast-receiving device 130.

TABLE 1
Extended OCAP 2.0 Standard of the Data-Broadcast-Receiving
Device 130

| | EXTENDED OCAP 2.0 SPECIFICATION |
|---|---|
| | OF DATA-BROADCAST- |
| ITEM | RECEIVING DEVICE 130 |
| JVM | JVM (BASED ON CONNECTED DEVICE |
| | CONFIGURATION (CDC)) |
| OCAP-HTML | HTML 4.0 |
| (DVB-HTML) | EXTENSIBLE HTML (XHTML) 1.0 |
| | CASCADING STYLE SHEETS (CSS) 1/2/2.1 |
| | European Computer Manufacturers Association |
| | Script 3 (ECMAScript 3) (JavaScript 1.3) |
| | DOCUMENT OBJECT MODULE (DOM) 1/2 |
| OCAP | HOME AUDIO VIDEO INTEROPERABILITY |
| APPLICATION UI | (HAVi) Level 2 UI (MULTI DEVICE |
| AND GRAPHIC | SUPPORT) |
| OCAP EVENT AND | OCAP EVENT API, OCAP UI EVENT API+ |
| UI EVENT API | (NOTIFY HANA EVENT, ADD API PACKAGE |
| | FOR CORRESPONDING TO CEA 931B) |
| OCAP-RESOURCE- | MULTI-DEVICE, HANA DTV RESOURCE |
| MANAGING API | MANAGER SUPPORT |
| CEA STANDARD | CEA 2027A WEB SERVER SUPPORT |
| | ADD API PACKAGE |
| OCAP FOR IEEE | IEEE 1394 NODE INTERFACE |
| 1394 | (API PACKAGE EXTENSION FOR |
| | SUPPORTING HANA IEEE 1394 |
| | STACK INTERFACE) |
| | VIDEO OUTPUT PORT |
| | (ISO CHANNEL INTERFACE SUPPORT API |
| | PACKAGE EXTENSION) |
| | OCAP NET API |
| | (INTERNET PROTOCOL Over IEEE 1394 |
| | SUPPORT API PACKAGE EXTENSION) |

That is, the extended OCAP 2.0 includes the JVM based on the CDC, and the HAVi UI for the OCAP application UI and OCAP application graphics.

In addition, the extended OCAP 2.0 may include OCAP resource-managing API that manages resources allocated for one or more devices connected to a predetermined device (e.g., HANA device). The extended OCAP 2.0 may also include an OCAP hardware API which includes IEEE 1394 node interface, a video output port interface, and OCAP net API. The extended OCAP 2.0 may also include CEA2027A and an API package for supporting a web server.

When a UI and a remote control input complying with CEA-931B, or a control based on a web browser and an instruction complying with CEA-2027A are received from the display device 170, they are mapped to the extended OCAP 2.0 via the mapping module 240.

After the mapping operation, an execution application and a presentation application are classified from a received broadcasting service based on the extended OCAP 2.0, and then the control module 200 controls the application-executing module 230 to process an execution application which executes a cable card, DSG, and a tuner, and transmits at least one of the EPG, VOD, and PPV to the display device 170 via the 1394 unsynchronized transmission channel 150 of the communication module 250.

A related art MPEG-2 transmission stream is transmitted via the 1394 isochronous transmission channel 160 of the communication module 250. The memory 210 can support the system specification of the control module 200.

FIG. 3 depicts a display apparatus according to an exemplary embodiment of the present invention.

The display device 170 executes at least one presentation application of EPG, PPV, and VOD classified by the data-broadcast-receiving device 130, and provides it to a user.

The display device 170 may include a communication module 300, a control module 310, a memory 320, an OCAP browser 330, an application-presenting module 340, and an A/V decoder 350.

The communication module 300 receives at least one presentation application of EPG, PPV and VOD from the data-broadcast-receiving device 130 via the 1394 unsynchronized transmission channel 150, and receives a related art A/V transmission stream via the 1394 isochronous transmission channel 160.

The control module 310 enables execution of the presentation application according to the extended OCAP 2.0 which includes the JVM based on CDC, and enables decoding of the A/V transmission stream transmitted from the data-broadcast-receiving device 130 via the 1394 isochronous transmission channel 160 by the A/V decoder 350 in a way of a related art.

The A/V stream decoded by the A/V decoder 350 is displayed with additional information processed by the application-presenting module 340 via a display module (not shown).

However, the presentation applications including at least one of an EPG, PPV, and VOD received by the 1394 unsynchronized transmission channel 150 are executed via the application-presenting module 340.

Here, the application-presenting module 340 includes a presentation engine and bridge engine of a related art OCAP 2.0, which can be separated or integrated as the application-presenting module 340 as shown in FIG. 3.

The presentation engine performs a function similar to that of a related art web browser through the display device 170 in order to provide web-based services. The related art OCAP 2.0 includes various extensions of Internet Explorer and Netscape such as XHTML 1.0, HTML 4.0.1, CSS 1/2, DOM 1/2, ECMAScript, SMPTE DDE-1, and SMPTE DOM-0.

In the extended OCAP 2.0, CSS 2.1 and ECMAScript 3 (Java Script 1.3) are extended.

To maximize a use efficiency of resources of the display device 170, a bridge engine integrating the presentation engine and execution engine is provided for the OCAP Java platform API.

The bridge engine enables applications to be linked within the presentation engine and the execution engine by permitting an access of the ECMAScript application and an access to a DOM file of the Java program.

The OCAP browser 330 is an OCAP-HTML supportable browser which is updated from a related art browser, and which can perform a browsing operation to enable a user to control peripherals.

The OCAP-HTML supportable browser processes documents made based on XML, and may be a related art XHT browser to which the OCAP-HTML support function is added.

Table 2 shows the extended OCAP 2.0 standard of the display device.

TABLE 2
Extended OCAP 2.0 Standard of Display Device

| | EXTENDED OCAP 2.0 SPECIFICATION |
|---|---|
| ITEM | OF DISPLAY DEVICE |
| JVM | JVM (BASED ON CDC) |
| OCAP-HTML | OCAP BROWSER |
| (DVB-HTML) | (OCAP-HTML SUPPORT) SIZE UPDATE |
| | BRIDGE ENGINE |
| | (EXTENSION FOR OCAP JAVA |
| | PLATFORM API) |
| OCAP EVENT AND | HANA EVENT NOTIFICATION |
| UI EVENT API | CEA-931B |
| CEA STANDARD | CEA-2027A |
| OCAP FOR IEEE 1394 | HANA 1394 STACK |

The memory 320, which is a related art storage medium, has to be enhanced for the control module 310 that supports the JVM.

That is, the display device 170 is a related art HANA digital TV, which includes the OCAP browser 330 that supports OCAP-HTML, and an application-presenting module 340, thereby performing its own process and displaying OCAP application UI written in Java and HTML.

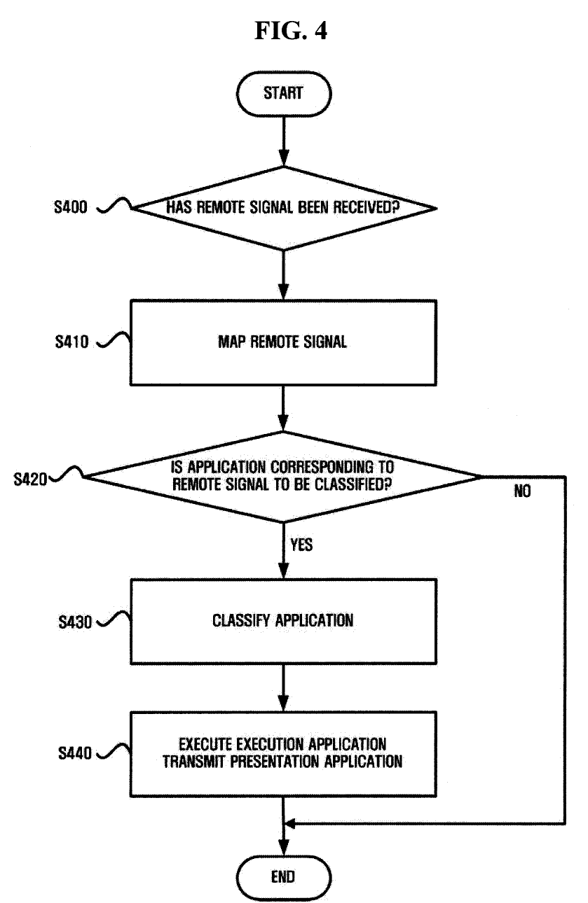

FIG. 4 is a flowchart of a data broadcast transmission according to an exemplary embodiment of the present invention.

FIG. 4 illustrates a flowchart showing that a predetermined broadcast service written in Java and HTML is transmitted from the data-broadcast-receiving device 130 to the display device 170.

As shown in FIG. 4, it is determined whether a remote signal corresponding to the CEA-2027A or CEA-931B standard is received from the display device 170 to the communication module 250 of the data-broadcast-receiving device 130 via the IEEE 1394 unsynchronized transmission channel 150 (S400).

When the predetermined remote signal corresponding to the CEA-2027A or CEA-931B standard is received via the IEEE 1394 unsynchronized transmission channel 150, the remote signal is mapped to the extended OCAP 2.0 via the mapping module 240 (S410).

When the remote signal is mapped to the extended OCAP 2.0 S410, it is determined whether to classify an application corresponding to the remote control of a user's request (S420).

If it is determined to classify an application corresponding to the remote signal in operation S420, a predetermined broadcasting service application, which is received from the head-end 100 and which is corresponding to the remote signal mapped to the extended OCAP 2.0, is classified by the application-classifying module 220 (S430). At this time, the classified application includes an execution application to be executed in the data-broadcast-receiving device 130 and a presentation application to be executed in the display device 170.

The classification of an application means that an OCAP-executing application such as DVB-Java, and an OCAP-presenting application such as DVB-HTML (OCAP_HTML) of a code group of OCAP system resources are classified.

The data-broadcast-receiving device 130 is operated by the application-executing module 230 that executes the execution application which executes a cable card, DSG, or tuner, and the presentation application including at least one of an EPG, PPV and VOD is transmitted to the display device 170 via the communication module 250 (S440).

The presentation application is transmitted via the 1394 unsynchronized transmission channel 150 of the communication module 250. A related art MPEG-2 transmission stream is transmitted to the display device 170 via the 1394 isochronous transmission channel 160 of the communication module 250.

That is, the data broadcast transmission classifies the execution application and the presentation application from the predetermined broadcasting service which is received from the head-end 100 and which is corresponding to the received remote signal of a user's request.

The execution application executable in the data-broadcast-receiving device 130 is processed via an execution engine of the extended OCAP 2.0. The presentation application is transmitted to the display device 170, and processed in a presentation engine of the extended OCAP 2.0.

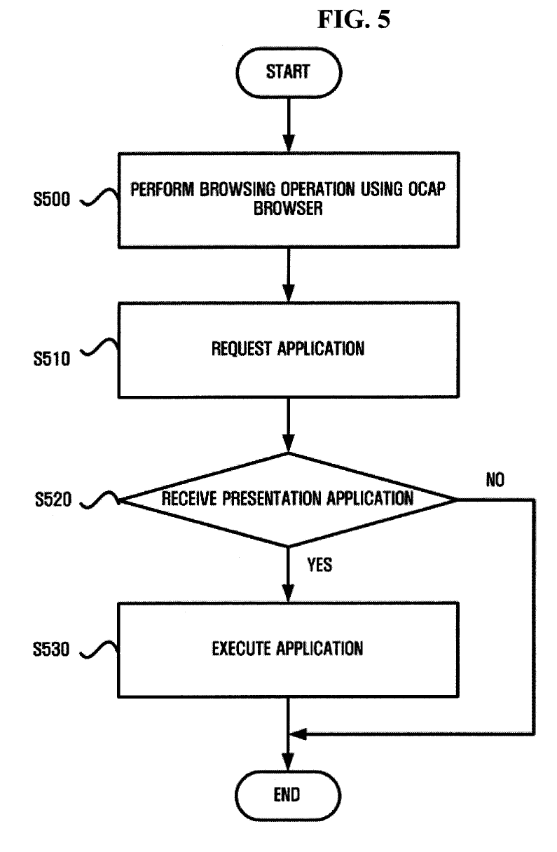

FIG. 5 is a flowchart of a data-broadcast reception according to an exemplary embodiment of the present invention.

The data-broadcast reception includes executing a presentation application by receiving the presentation application from the data-broadcast-receiving device 130.

A user performs an operation of browsing a desired application via the OCAP browser 330 provided with OCAP-HTML and HANA S500.

The browsing operation is to browse at least one of an execution application and a presentation application, which are written in Java and HTML, and classified by the data-broadcast-receiving device 130.

A user requests a desired application through the browsing operation (S510).

It is determined whether a predetermined application corresponding to the request for a desired application is received (S520).

The predetermined application refers to a presentation application, which is provided to the display device 170 via the 1394 unsynchronized transmission channel 150 of the communication module 250. A related art MPEG-2 transmission stream is provided via the 1394 isochronous transmission channel 160.

A presentation application if received at the display device 170 is compiled into the Java byte code format, and executed in the JVM.

The presentation application includes at least one of EPG, PPV, and VOD.

That is, the data-broadcast reception enables the Java application to be executed using the HTML-based application of a related art HANA device (the display device 170).

As described above, the data-broadcast-receiving device 130 and the display apparatus according to the exemplary embodiment of the present invention address one or more of the effects described below.

A broadcasting service written in Java and HTML can be provided to a HANA device, thereby implementing the HANA XHT standard.

The head-end 100 can link an OCAP-based two-way service to HANA, thereby sharing A/V connected to a home network.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data-broadcast-receiving apparatus comprising:
an application-classifying module that classifies a broadcast-service application into an execution application and a presentation application;
an application-executing module that executes the execution application; and
a communication module that transmits the presentation applications.

2. The apparatus of claim 1, wherein the application-classifying module classifies the broadcast-service application into the execution application and the presentation application according to extended OpenCable Application Platform (OCAP) 2.0.

3. The apparatus of claim 1, wherein the execution application executes at least one of a cable card, Data Over Cable Service Interface Specifications (DOCSIS) set-top gateway (DSG), and a tuner.

4. The apparatus of claim 1, wherein the communication module transmits the presentation application to a display device via an Institute of Electrical and Electronics Engineers (IEEE) 1394 unsynchronized transmission channel.

5. The apparatus of claim 2, wherein the extended OCAP 2.0 comprises a Java virtual machine (JVM) based on a connected device configuration (CDC).

6. The apparatus of claim 2, wherein the extended OCAP 2.0 comprises a home audio/video interoperability (HAVi) user interface for an OCAP application user interface and OCAP application graphics.

7. The apparatus of claim 2, wherein the extended OCAP 2.0 comprises an OCAP-resource-managing application program interface (API) that manages resources allocated for one or more devices connected to a predetermined device.

8. The apparatus of claim 2, wherein the extended OCAP 2.0 comprises an API package for supporting Consumer Electronics Association (CEA)-2027A and a web server.

9. The apparatus of claim 2, wherein the extended OCAP 2.0 comprises an OCAP hardware API comprising an IEEE 1394 node interface, a video output port interface, and an OCAP net API.

10. A display apparatus comprising:
an OpenCable Application Platform (OCAP) browser that browses a broadcast service using OCAP-Hypertext Markup Language (HTML);
a communication module that receives an application corresponding to the browsing by the OCAP browser; and
an application-presenting module that executes the received application.

11. The apparatus of claim 10, wherein the browsing of the broadcast service, the receiving of the application, and the executing of the received application are performed according to at least one of Consumer Electronics Association (CEA)-2027A and CEA-931B.

12. The apparatus of claim 10, wherein the application-presenting module comprises a bridge engine for an OCAP Java platform application program interface (API).

13. The apparatus of claim 10, wherein the received application comprises at least one of an electronic program guide (EPG), pay per view (PPV) and video on demand (VOD).

14. The apparatus of claim 10, wherein the application-presenting module executes the received application according to extended OCAP 2.0 comprising a connected device configuration (CDC)-based Java virtual machine (JVM).

15. The apparatus of claim 10, wherein the application-presenting module executes the presenting application by using at least one of HTML 4.0, XHTML 1.0, CSS 1/2/2.1, ECMAScript 3, and DOM 1/2.

16. The apparatus of claim 14, wherein the extended OCAP 2.0 includes an API for high definition audio video network alliance (HANA) event notification.

17. A data-broadcast-receiving method comprising:
classifying a broadcast-service application into an execution application and a presentation application;
executing the execution application; and
transmitting the presentation application.

18. The method of claim 17, wherein the classifying is performed according to extended OpenCable Application Platform (OCAP) 2.0.

19. The method of claim 17, wherein the executing executes an application that executes at least one of a cable card, a Data Over Cable Service Interface Specifications (DOCSIS) set-top gateway (DSG), and a tuner.

20. The method of claim 17, wherein the transmitting the presentation application comprises transmitting the presentation application to a display device via an Institute of Electrical and Electronics Engineers (IEEE) 1394 unsynchronized transmission channel.

21. The method of claim 18, wherein the extended OCAP 2.0 comprises a Java virtual machine (JVM) based on a connected device configuration (CDC).

22. The method of claim 18, wherein the extended OCAP 2.0 comprises a home audio/video interoperability (HAVi) user interface for an OCAP application user interface and OCAP application graphics.

23. The method of claim 18, wherein the extended OCAP 2.0 comprises an OCAP-resource-managing application program interface (API) that manages resources allocated for one or more devices connected to a predetermined device.

24. The method of claim 18, wherein the extended OCAP 2.0 comprises an API package for supporting Consumer Electronics Association (CEA)-2027A and a web server.

25. The method of claim 18, wherein the extended OCAP 2.0 comprises an OCAP hardware API comprising comprising an IEEE 1394 node interface, a video output port interface, and an OCAP net API in an OCAP net API.

26. The method of claim 18, wherein the executing executes the presenting application by using at least one of Hypertext Markup Language (HTML) 4.0, extensible HTML (XHTML) 1.0, Cascading Style Sheets (CSS) 1/2/2.1, ECMAScript 3, and DOM 1/2.

27. A display method comprising:
browsing a broadcasting service using OpenCable Application Platform-Hypertext Markup Language ((OCAP-HTML);
receiving an application corresponding to the browsing the broadcasting service; and
executing the received application.

28. The method of claim 27, wherein the browsing, the receiving, and the executing is performed according to at least one of Consumer Electronics Association (CEA)-2027A and CEA-931B.

29. The method of claim 27, wherein the executing uses a bridge engine for an OCAP Java platform application program interface (API).

30. The method of claim 27, wherein the received application comprises at least one of an electronic program guide (EPG), pay per view (PPV) and video on demand (VOD).

31. The method of claim 27, wherein the executing executes the received application according to extended OCAP 2.0 including a connected device configuration (COC)-based Java virtual machine (JVM).

32. The method of claim 31, wherein the extended OCAP 2.0 includes an API for high definition audio video network alliance (HANA) event notification.
